(19) United States
(12) Patent Application Publication
(10) Pub. No.: US 2024/0305769 A1
(43) Pub. Date: Sep. 12, 2024

(54) ADAPTIVE CONFIGURATION OF VIDEO ENCODER PRESET MODES

(71) Applicant: Intel Corporation, Santa Clara, CA (US)

(72) Inventors: Jason Daniel Tanner, Folsom, CA (US); James Holland, Folsom, CA (US); Stanley Jacob Baran, Chandler, AZ (US); Satya Yedidi, Roseville, CA (US); Penne Yat-Pei Lee, Bellevue, WA (US); Sumit Bhatia, Folsom, CA (US)

(21) Appl. No.: 18/665,184

(22) Filed: May 15, 2024

(51) Int. Cl. H04N 19/103; H04N 19/136; H04N 19/172; H04N 19/177

(52) U.S. Cl. CPC H04N 19/103; H04N 19/136; H04N 19/172; H04N 19/177

(57) ABSTRACT

Systems, apparatus, articles of manufacture, and methods are disclosed of adaptive configurations of video encoder preset modes. An example apparatus comprising interface circuitry to obtain a video to be encoded, instructions, and at least one processor circuit to be programmed by the instructions to configure a video encoder to encode a first frame of the video based on a first preset mode of a plurality of preset modes associated respectively with a plurality of different relative encoder performance targets, select a second preset mode of the plurality of preset modes based on one or more characteristics associated with a second frame of the video, the second preset mode different from the first preset mode, and configure the video encoder to encode the second frame based on the second preset mode.

### BACKGROUND

Video encoders have numerous encoding parameters that impact the quality, which may be measured as compression efficiency, and performance, which may be measured as encoding speed, with which the encoder can encode a piece of video. As such, modern video encoders support several preset modes that configure the encoding parameters with specific values, settings, ranges, etc. Different preset modes provide different trade-offs between compression efficiency (e.g. encoder quality), and performance (e.g., encoding speed).

### BRIEF DESCRIPTION OF THE DRAWINGS

FIG. 1 is a block diagram of an example environment in which an example preset mode selection circuitry operates to adaptively configure video encoder preset modes.

FIG. 2 is a block diagram of an example implementation of the preset mode selection circuitry of FIG. 1.

FIG. 3 is a graph illustrating example quality bitrate tradeoffs for different preset modes.

FIG. 4 is a graph illustrating example performance results for high efficiency video coding (HEVC) of different types of video for different quantization parameters (QPs).

FIG. 5 is an example of frame distribution of a 720 lines progressive (720p) video at different QP and different bitrates.

FIGS. 6 and 7 are flowcharts representative of example machine readable instructions and/or example operations that may be executed, instantiated, and/or performed by example programmable circuitry to implement the preset mode selection circuitry of FIG. 2.

FIG. 8 is a block diagram of an example processing platform including programmable circuitry structured to execute, instantiate, and/or perform the example machine readable instructions and/or perform the example operations of FIGS. 6-7 to implement the preset mode selection circuitry of FIG. 2.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIGS. 6-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Video encoders are used to reduce the size of input video for easier storage, transmission, etc. Video encoders include a preset mode input to set the configurable encoding parameters of the video encoder to a particular combination of settings. For example, different combinations of encoding parameter settings can affect the encoder's performance (e.g., encoding speed) and quality (e.g., encoder compression efficiency). To simplify configuration of encoding parameter in video encoder, a preset mode input enables selection of one of a finite set of preset modes that cause the video encoder to be configured with a particular combination of encoding parameter settings corresponding to the selected preset mode. For example, the preset mode input can be set to a quality mode which prioritizes quality (e.g., encoder compression efficiency) over performance (e.g., encoding speed). As another example, the preset mode input can be set to a performance mode which prioritizes encoding speed and sacrifices the encoder's compression efficiency. In some example video encoder, the preset mode is referred to as the encoder's presets, the encoder's target usage (TU), the encoder's encode mode, the encoder's configuration or initial configuration, etc.

Video encoders can have multiple preset modes that are associated respectively with different relative encoder performance targets that optimize the trade-offs between compression efficiency, also referred to as encoder quality, and performance, also referred to as encoding speed. The different preset modes can be unique to each encoder. For example, a video encoder may support selection of one of a group of possible preset modes or target usage (TU) modes ranging from target usage 1 (TU1) to target usage 7 (TU7). The different TU modes are based on different performance and quality tradeoffs. In an example, TU1 has the best quality encoding but slowest encoding performance and is referred to as a “very slow” preset mode. Target usage 2 (TU2) is close to TU1 quality but with faster performance. TU2 is referred to as a “slower” preset mode. Target usage 3 (TU3) is between target usage 4 (TU4) and TU2 and is referred to as a “slow” preset mode. The different slow preset modes prioritize compression efficiency over encoding speed and may use more complex encoding algorithms and dedicate more computational resources to achieve higher compression ratios. As a result, encoding times are slower compared to other presets (e.g., TU4-TU 7), but the resulting video files are typically smaller with better quality. In contrast, TU4 has balanced performance and quality. TU4 is referred to as a “medium” preset mode. Medium preset mode offers a good compromise between compression efficiency and encoding speed. It produces smaller file sizes compared to the fast preset mode but may take longer to encode. Target usage 5 (TU5) is between target usage 6 (TU6) and TU4. TU5 is referred to as a “fast” preset mode. Fast preset mode is a balance between compression efficiency and encoding speed. It provides decent compression while still maintaining relatively fast encoding times. TU6 is close to TU4 or TU5 quality but with faster performance. TU6 is referred to as “faster” preset mode. TU7 is the fastest encoder speed setting with the biggest drop in quality. TU7 is referred to as “very fast” preset mode. TU7 prioritizes encoding speed over compression efficiency. It uses less computational resources and simpler encoding algorithms, resulting in faster encoding times but potentially larger file sizes compared to other preset modes.

Generally, an encoder's preset mode is statically assigned or selected at the start of an encoding session, or a user may rely on a default preset mode provided by an encoder manufacturer. Typically, users do not change the video encoder's preset mode. However, the preset mode impacts the encoder's quality (e.g., compression efficiency), and performance (e.g., encoding speed) if a suboptimal setting is selected for an input video.

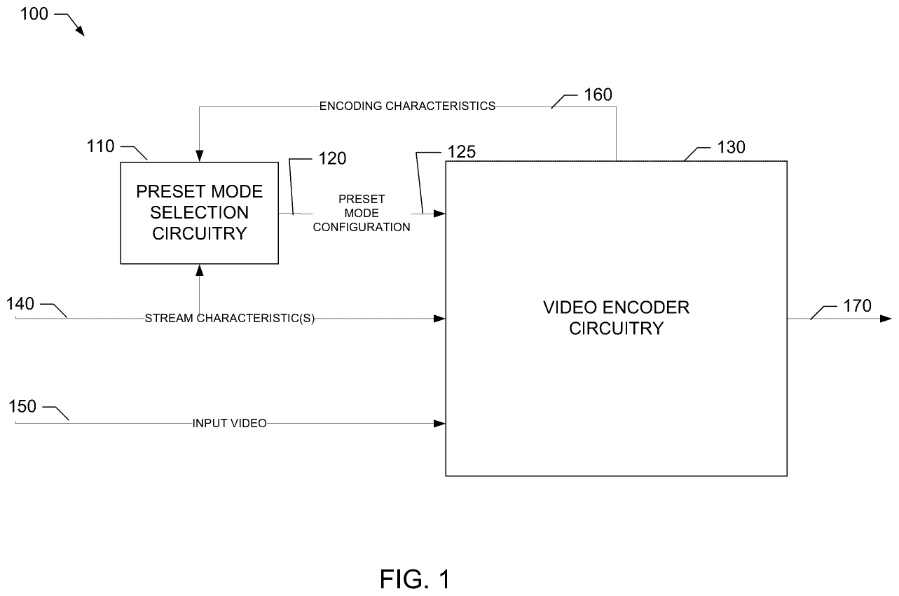

Examples disclosed herein are directed to dynamically adjusting a video encoder's configuration by dynamically selecting a preset mode based on characteristics of the input video received. The dynamic preset mode selection is advantageous to end users as it enables selection of a preset mode targeted to (e.g., optimized for) a given input video without user intervention. The dynamically selected preset mode optimizes the trade-offs between compression efficiency (e.g., encoder quality) and performance. As noted above, a particular preset mode provides a particular combination of encoding parameters used to configure the video encoder. Examples of encoding parameters include bitrate, motion estimation, quantization, entropy coding, prediction structure, frame reference structure, transform types, other encoding mode decision features, etc. The video encoder preset mode to be dynamically selected is influenced by various input video characteristics, which are discussed below in connection with FIG. 1. Examples of input video characteristics are input video's resolution, frame rate, complexity of the input video's scenes, content type, noise, temporal consistency, spatial details, visual metric quality, etc.

FIG. 1 is a block diagram of an example environment 100 in which example preset mode selection circuitry 110 operates to adaptively select a preset mode to configure a video encoder's encoding parameters. The example environment 100 includes the example the preset mode selection circuitry 110, example preset mode value 120, example preset mode input 125, example video encoder circuitry 130, example stream characteristic(s) 140, example input video 150, example encoding characteristic(s) 160, and example encoded output video 170.

The preset mode selection circuitry 110 selects the preset mode value 120 to provide to the preset mode input 125 used to configure the video encoder circuitry 130. The preset mode input 125 sets the encoding parameters of the video encoder circuitry 130. The preset mode selection circuitry 110 selects a preset mode based on a tradeoff between the video encoder's compression efficiency (e.g., quality), and encoding speed (e.g., performance). In the illustrated examples, the preset mode selection circuitry 110 selects the preset mode value 120 based on the stream characteristics 140 associated with the input video 150 and encoding characteristics 160 associated with a given frame of the input video 150. The video encoder circuitry 130 encodes the input video 150 and outputs an encoded output video 170. The video encoder circuitry 130 can implement any video encoder and/or combination of video encoders that support preset mode configuration. For example, the video encoder circuitry 130 can implement one or more of H.264, also referred to as advanced video coding (AVC), H.265, also referred to as high efficiency video coding (HEVC), H.266, also referred to as versatile video coding (VVC), AV1, VP9, MPEG-4, etc.

In some examples, the preset mode value 120 is a data value that instructs the video encoder circuitry 130 to select the appropriate set of encoding parameters corresponding to the selected preset mode. The preset mode value 120 identifies the chosen preset mode from a set or range of available preset modes for the video encoder circuitry 130. In some examples, the preset mode value 120 applied to the preset mode input 125 is used by the video encoder circuitry 130 to look up the particular combination of encoding parameters settings associated with the selected preset mode in a lookup table or other data structure and the set the encoder's encoding parameters based on those settings. Preset modes may be named based on the characteristics of the encoding parameter. Some examples of preset modes as described above are very slow, slower, slow, medium, fast, faster, very fast mode.

In the illustrated example, the preset mode selection circuitry 110 selects a preset mode that strikes a balance between compression efficiency (e.g. quality) and encoding speed (e.g., performance) based on the input video 150. A preset mode that prioritizes speed (e.g., high-speed encoding) may sacrifice (e.g., trade-offs) a certain degree of compression efficiency, while a preset mode that focuses on increasing compression efficiency may require more computational resources and time for encoding. The preset mode selection circuitry 110 of the illustrated example selects a first or initial preset mode for the video encoder circuitry 130 based on the stream characteristics 140 of the input video 150. Example stream characteristics 140 include, but are not limited to, bitrate, resolution, frame rate, or GOP structure of the input video 150.

For example, if the bitrate of the input video 150 is very low, which means there are fewer bits available to represent each frame of video, this may lead to challenges in maintaining an acceptable quality of the encoded video output 170. The low bitrate may make it difficult to properly capture the details present in the input video 150, which can lead to compression artifacts such as blurring, or pixelation in areas of high motion or fine details. For input video 150 with low bitrate, the preset mode selection circuitry 110 may prioritize compression efficiency to make the most out of the available data. For example, the preset mode selection circuitry 110 may select a preset mode such as the “slower” preset mode described above to improve the quality of the encoded video 170 by allocating more computational resources and time for compression.

Conversely, as the bitrate increases, there may not be a noticeable difference in the encoded output video 170 since the different preset modes may each produce a visually lossless encoded output video 170. A visually lossless video is an output video where the data that is lost after the video is compressed is not detectable to the human eye. At a high bitrate, many different preset modes may produce a visually lossless encoded output video because the increased bitrate provides more data to represent the details and complexity of the video content. For example, a 1080 progressive scan (1080p) resolution video may be visually lossless at a bit rate of 40 megabits per second (40 Mbps). When the bitrate is high, the preset mode selection circuitry 110 does not need to increase the compression efficiency (e.g., quality) since there will not be a difference in the encoded output video 170 if the compression efficiency is increased. As such, at a high bitrate, the preset mode selection circuitry 110 may prioritize encoding speed and switch to the “faster” preset mode described above that increases encoding speed by 2 to 5 times the normal speed.

Another example of the stream characteristics 140 that may influence preset mode selection by the preset mode selection circuitry 110 is the resolution of the input video 150. The resolution determines the level of detail and clarity present in the video frames. An input video 150 with high resolution includes more detail and complexity which requires more time to encode compared to lower resolution videos. In some examples, the preset mode selection circuitry 110 selects the “slower” preset mode described above, which is optimized for better compression efficiency, for high resolution input video 150 and selects the “faster” preset mode described above, which is optimized for speed, for lower resolution videos.

Frame rate is another example stream characteristic 140 of the input video 150 that may influence preset mode selection by the preset mode selection circuitry 110. When a frame rate of the input video 150 is high, more processing time is required during encoding compared to lower frame rates. In some examples, the preset mode selection circuitry 110 selects a preset mode that prioritizes faster encoding speeds to keep up with a real-time processing requirement. High frame rate may also have high motion changes between frames. In some examples, the preset mode selection circuitry 110 may select a preset mode optimized for better compression efficiency to produce smooth motion in the encoded video 170. In some examples, the choice of preset mode by the preset mode selection circuitry 110 depends on a desired balance between encoding speed and quality. If the frame rate is low, there are fewer frames per second, and the preset mode selection circuitry 110 may select a “faster” preset mode optimized for speed or a “medium” preset mode that balances between encoding speed and compression efficiency. However, if the low frame rate input video 150 requires faster encoding speed due to real-time processing constraints, the preset mode selection circuitry 110 may select a preset mode optimized for faster encoding speed, such as “faster” or “very fast” preset modes described above.

In video encoding, the input video 150 is typically processed frame by frame. Each frame represents a snapshot of the video at a specific point in time. In some examples, after a first frame is encoded based on the first or initial preset mode, which was set based on the stream characteristics 140, the preset mode selection circuitry 110 of the illustrated example adjusts or updates the first or initial preset mode to a same or different second or subsequent preset mode based on a set of encoding characteristics 160 associated with a given (e.g., second) frame of the input video 150 to be encoded. In some examples, encoding characteristics such as a frame type of the given frame in a group of pictures (GOP) is used by the preset mode selection circuitry 110 determine the second preset mode. For example, the preset mode selection circuitry 110 selects a second preset mode to encode a second frame based on whether the second frame is a reference frame in the GOP. Also, when optimizing encoding at a group of pictures (GOP) level, the preset mode selection circuitry 110 can vary the selection of preset mode based on a level of a bidirectional frame (B frame) hierarchy. The B frame hierarchy refers to the organization and structure of B frames within a GOP in a video stream 150. B frames are bi-directionally predicted frames that rely on both preceding and subsequent frames for motion estimation and compensation. The B frame hierarchy determines the order and relationships between different levels of B frames within a GOP. Examples of different levels of B frames include a top level of a B frame, and a non-reference B frame. A top level of a B frame hierarchy includes B frames that serve as reference frames for subsequent B frames. These frames play a role in predicting motion and maintaining video quality. In some examples, for top level B frame hierarchy, the preset mode selection circuitry 110 selects a “very slow” preset mode that provides high compression efficiency and slow encoding speed to ensure accurate motion prediction and detail preservation. Non-reference B frames have less impact on overall video quality, as they rely on reference frames for prediction. Therefore, in some examples, the preset mode selection circuitry 110 selects a “faster” preset mode for non-reference B frames. A “faster” preset mode provides high encoding speed for non-reference B frames. This preset mode reduces encoding time without affecting video quality.

In some examples, the preset mode selection circuitry 110 selects a preset mode based on content awareness. For example, the preset mode selection circuitry 110 becomes content aware by monitoring the set of encoding characteristics 160 associated with a given frame to be encoded. Example encoding characteristics 160 include visual quality metrics associated with the second frame. Examples of visual quality metrics include signal-to-noise (SNR) ratio characteristics, prior encoding sizes, quantizer characteristics, content types, etc.

An SNR metric represents the ratio of a signal power to a noise power in a video signal, indicating the quality of the signal relative to the level of noise present. A peak signal-to-noise ratio (PSNR) is a metric used in video encoding to quantify the quality of a compressed video compared to the original uncompressed video. The PSNR measures the difference between the original video and the compressed video in terms of signal power and noise (e.g., distortion) introduced during compression). The signal in PSNR refers to the original video data before any compression is applied. In video encoding, the noise refers to the distortion or error introduced during the compression process. The distortion arises from various factors, including quantization, spatial and temporal compression artifacts, and other compression techniques used to reduce the bitrate of the video. The noise represents the deviation from the original signal caused by compression. The noise which represents the distortion or error introduced during compression is quantified and evaluated against the original uncompressed video signal to assess the quality of the compressed video.

In scenarios where the quality of the compressed video is high (e.g., high PSNR), the preset mode selection circuitry 110 may select a “fast” preset mode that provides a fast encoder speed that stays within the quality target, because there may be less complexity in the input video. As such, faster encoding speed can be achieved without sacrificing compression efficiency, allowing for quicker encoding time. Conversely, in situations with a low PSNR (e.g., quality of the compressed video is low), the preset mode selection circuitry 110 may select a “slower” preset mode that provides improved compression efficiency to avoid amplifying compression artifacts but at a lower encoding speed to maintain an acceptable encoded output video 170. For example, a slower encoding speed may help ensure accurate motion estimation and preserve details.

In some examples, another encoding characteristic 160 that affects the selection of a second or updated preset mode by the preset mode selection circuitry 110 is the prior encoding size, which refers to the size of previously encoded frames or groups of pictures (GOPs). With a small prior encoding size, there might be more redundant or easily compressible information in the video stream. The preset mode selection circuitry 110 may select a “fast” preset mode with good compression efficiency. Since the amount of data to process is small, encoding speed may be faster compared to encoding larger video files. Less data means less computation required for compression, which can result in quicker encoding times.

In some examples, another encoding characteristic 160 associated with encoding a given frame, which may be used by the preset mode selection circuitry 110 to select/update the preset mode, is a quantizer characteristic. A quantizer value is a parameter that determines the level of quantization applied to transform coefficients during the encoding process. During quantization, the video encoder circuitry 130 divides the transformed coefficients by a set of quantization values. The quantization values determine how finely or coarsely the coefficients are quantized. A high quantizer value results in more quantization, and a lower quantizer value leads to finer quantization and better-quality output. A high quantizer value reduces the number of bits used to represent each coefficient resulting in more compression and smaller file sizes. In some examples, the preset mode selection circuitry 110 may select a “faster” preset mode because a high quantizer value involves less computational resources and results in faster encoding speed. In contrast, a low quantizer value preserves more detail but leads to larger file sizes. The preset mode selection circuitry 110 may select a “slower” preset mode in such examples because a low quantizer value has more details and may result in a slower encoding speed to achieve a desired compression efficiency. Quantizer values are often represented using a quantization parameter (QP). The QP value determines the overall quantization level applied to the video frames. Different regions of the video frame or different types of frames (e.g., intra-coded frames (I-frames), predicted frames (P-frames), bi-directional predicted frames B-frames) may use different QP values to achieve optimal compression efficiency. Therefore, in some examples, the preset mode selection circuitry 110 selects a “faster” preset mode for a high quantizer value and selects a “slower” preset mode for a low quantizer value.

In some examples, if content of the input video 150 is simple, a “fast” preset mode and a “slow” preset mode may yield similar encoding quality. In some such examples, the preset mode selection circuitry 110 selects a “faster” preset mode for the simple content to achieve good performance. But as the content of the input video 150 becomes more complicated, the preset mode selection circuitry 110 selects “slower” preset mode to achieve better encoding quality.

In some examples, the encoding characteristics 160 includes lookahead information that is used to inform decisions about compression parameters, motion estimation, and bitrate allocation. Lookahead information can be based on both temporal (e.g., time-based) and spatial (e.g., pixel-based) complexity. Temporal complexity lookahead involves analyzing future frames in a video sequence to anticipate changes in motion and scene dynamics. By examining the motion characteristics of upcoming frames, the preset mode selection circuitry 110 of the illustrated example is able to select a preset mode that adjusts motion estimation parameters and predicts motion more accurately. For example, in scenes with rapid motion or sudden changes, temporal complexity lookahead informs the preset mode selection circuitry 110 to select a “slow” preset mode that configures the encoding parameters to increase compression efficiency settings to preserve encoding quality. Spatial complexity lookahead involves analyzing regions of high spatial detail or complexity within a current frame or future frames. By identifying areas of high detail or texture complexity, the preset mode selection circuitry 110 can select a “slower” preset mode that configures the encoding parameters in a video encoder circuitry 130 to preserve details in those regions or increase compression efficiency settings to reduce (e.g., minimize) artifacts.

In some examples, the preset mode selection circuitry 110 selects a second (e.g., updated) preset mode based on comparison of a visual quality metric to a threshold. In some examples, the threshold value corresponds to a value of the visual quality metric that represents visually lossless quality. This means that the encoded video 170 is perceptually indistinguishable from the original input video 150 to a human eye. In some examples, after the preset mode selection circuitry 110 identifies a particular preset mode that achieves visually lossless quality, the preset mode selection circuitry 110 adjusts the preset mode to a higher performance mode (e.g., faster encoding speed) and sets that particular preset mode as the default preset mode for encoding. As such, that particular preset mode will be used for regular encoding tasks, ensuring consistent encoding quality while optimizing performance. However, if the quality metric is not visually lossless (e.g., does not meet the threshold), the preset mode selection circuitry 110 may adjust the preset mode to a “slow” preset mode to meet the quality target and reduce the performance (e.g., encoding speed) within the performance target. The preset mode selection circuitry 110 may select a tradeoff that improves quality over performance.

One of the encoding processes in the video encoder circuitry 130 is bitstream packing. Bitstream packing involves organizing and formatting compressed video data into structure bitstream for transmission or storage. In some encoding scenarios, the bitstream packing portion of the video encoder 130 will be context adaptive binary arithmetic coding (CABAC) limited. Being CABAC limited means that the encoding process is constrained by the performance of the CABAC algorithm during bitstream packing. This is a separate state in the encoding process than the preset mode selection decision which selects a particular combination of encoding parameters based on input video content and desired encoding quality. The CABAC encoding process can computationally intensive, especially during the bit packing process, where entropy coding is applied to compress the encoded video data. If the complexity of the CABAC encoding exceeds the available computational resources or processing capacity, this leads to a CABAC limitation (e.g., bottleneck in the encoding process). This bottleneck may arise due to factors such as computational complexity, memory bandwidth constraints or algorithmic inefficiency within the CABAC implementation.

The first frame in the input video 150 often serves as a reference frame, and subsequent frames (e.g., a second frame) includes information about changes in the video scene relative to this reference frame. The encoding time of a frame refers to the duration it takes for the video encoder circuitry 130 to compress a particular frame. Several factors can influence the encoding time, including the complexity of the frame's content, the efficiency of the encoding algorithms and the encoder parameter settings corresponding to the selected preset mode of the video encoder circuitry 130. In a situation where the encoding time of a second frame is not limited by the CABAC limited bit packing operation of the video encoder circuitry 130 and the characteristic of the second frame, the preset mode selection circuitry 110 may in some examples set up a better quality mode within the performance target. In some examples, the preset mode selection circuitry 110 may retain the first preset mode (e.g., default manufacturer set preset mode or an initially assigned preset mode) to encode the second frame. In a situation where the encoding time of a second frame is limited by the CABAC limited bit packing operation of the video encoder 130, the preset mode selection circuitry 110 will select a “slower” preset mode that provides high compression efficiency and low encoding speed to encode the second frame.

In some examples, the preset mode selection circuitry 110 selects a preset mode based on a set of characteristics of the second frame and whether the second frame corresponds to a scene change. Scene changes correspond to transitions in a video, such as a cut, fade, abrupt change in content, etc. During a scene change in a video, spatial complexity increases due to the addition of visual elements such as new objects, textures, or backgrounds. Some scene changes may include transition effects, such as fades, wipes, or cuts. These effects may involve complex visual patterns or overlays, further contributing to the spatial complexity of the frames during the transition. If a given frame to be encoded corresponds to a scene change, the preset mode selection circuitry 110 may select a “slower” preset mode that offers high compression efficiency and better preservation of details to encode that frame.

In some examples, the preset mode selection circuitry 110 selects an updated preset mode to encode a given frame based on a set of characteristics of the given frame and a determination that a time to encode the given frame satisfies a threshold, such as achieving real-time encoding. For example, to achieve real-time encoding, the preset mode selection circuitry 110 may select a “faster” preset mode with fast encoding speed in order to meet the real-time requirements.

The video encoder circuitry 130 has multiple encoder parameters to increase encoding performance (e.g., encoding speed) or encoding quality (e.g., compression efficiency) of the video encoder circuitry 130. In examples described herein, the encoder parameters are dynamically set by the preset mode selection circuitry 110 by dynamically selecting among different available preset modes to provide a particular performance-quality tradeoff in the encoded output video 170.

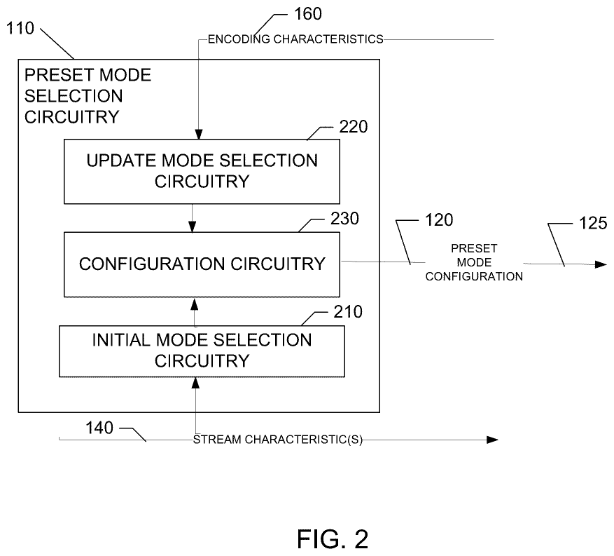

FIG. 2 is a block diagram of an example implementation of the preset mode selection circuitry 110 of FIG. 1 to adaptively configure video encoder preset modes. The preset mode selection circuitry 110 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the preset mode selection circuitry 110 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The preset mode selection circuitry 110 includes example initial mode selection circuitry 210, example update mode selection circuitry 220, and an example configuration circuitry 230. The initial mode selection circuitry 210 selects an initial or first preset mode based on a set of one or more stream characteristics 140 (FIG. 1) associated with the input video 150 (FIG. 1), as described above in connection with FIG. 1. The initial mode selection circuitry 210 selects a first preset mode based on stream characteristics 140 such as bitrate, resolution, frame rate, or GOP structure of the input video 150.

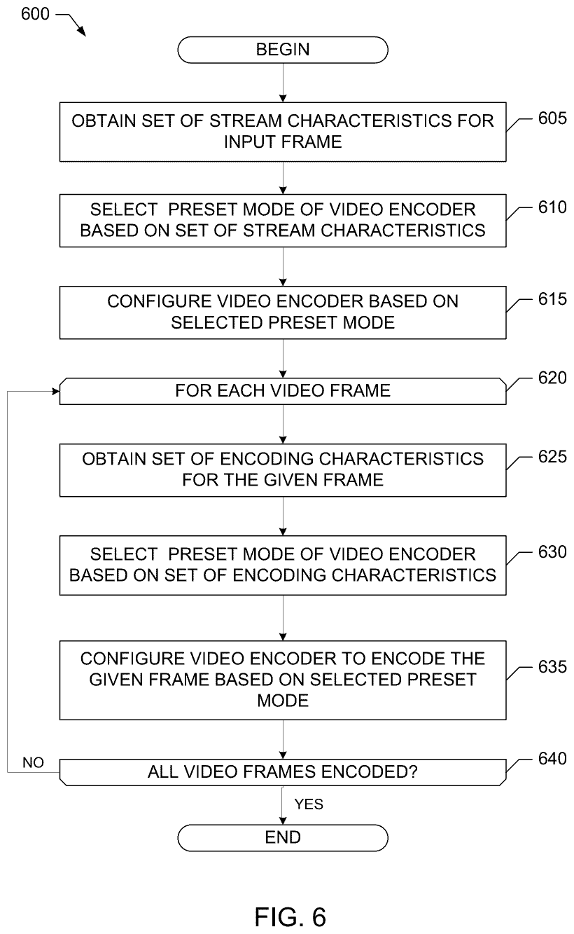

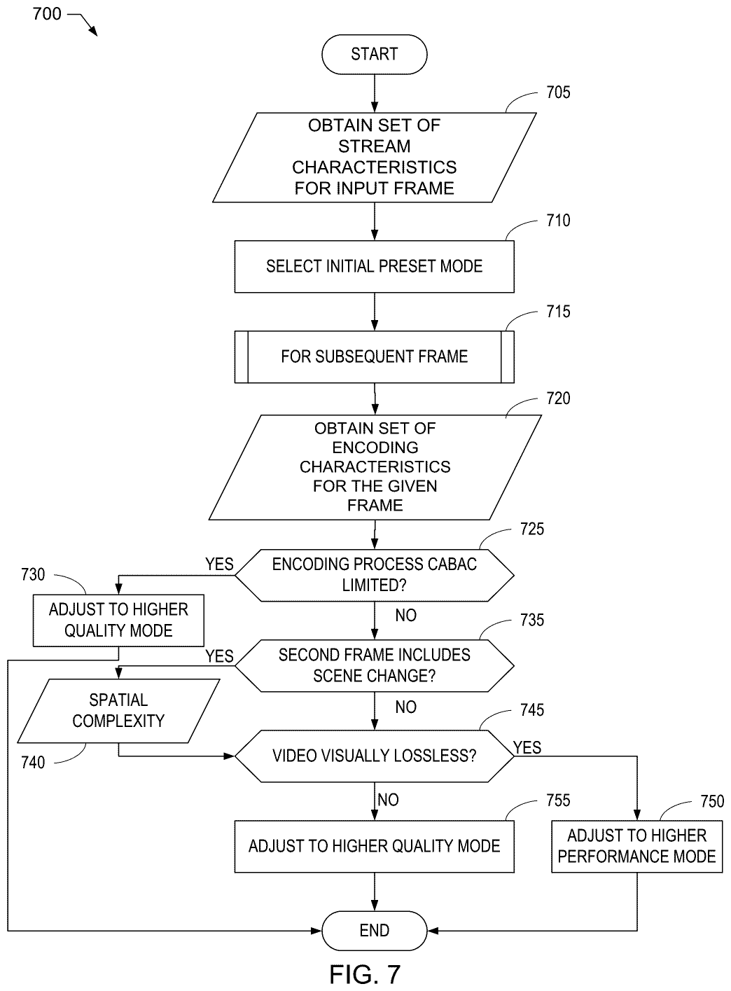

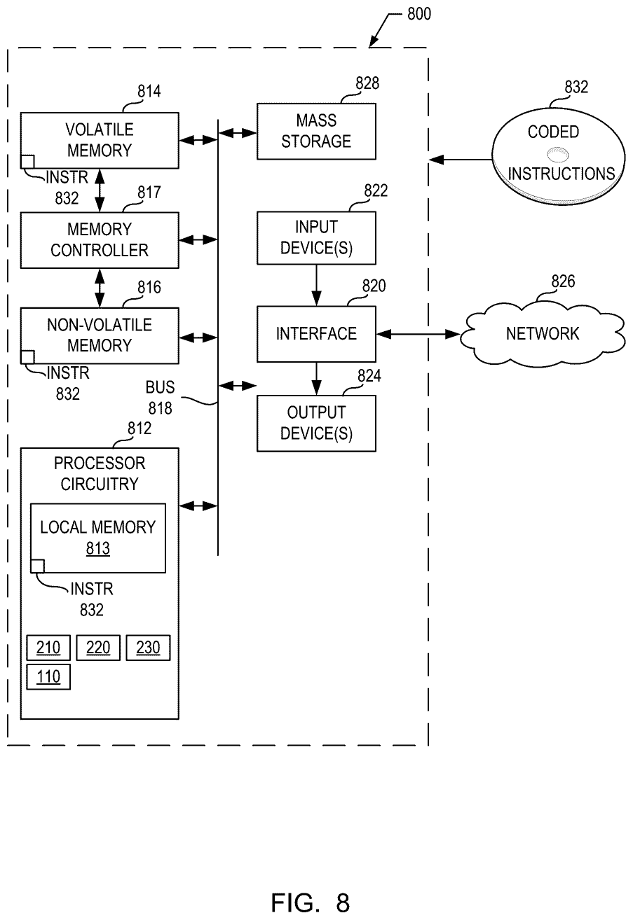

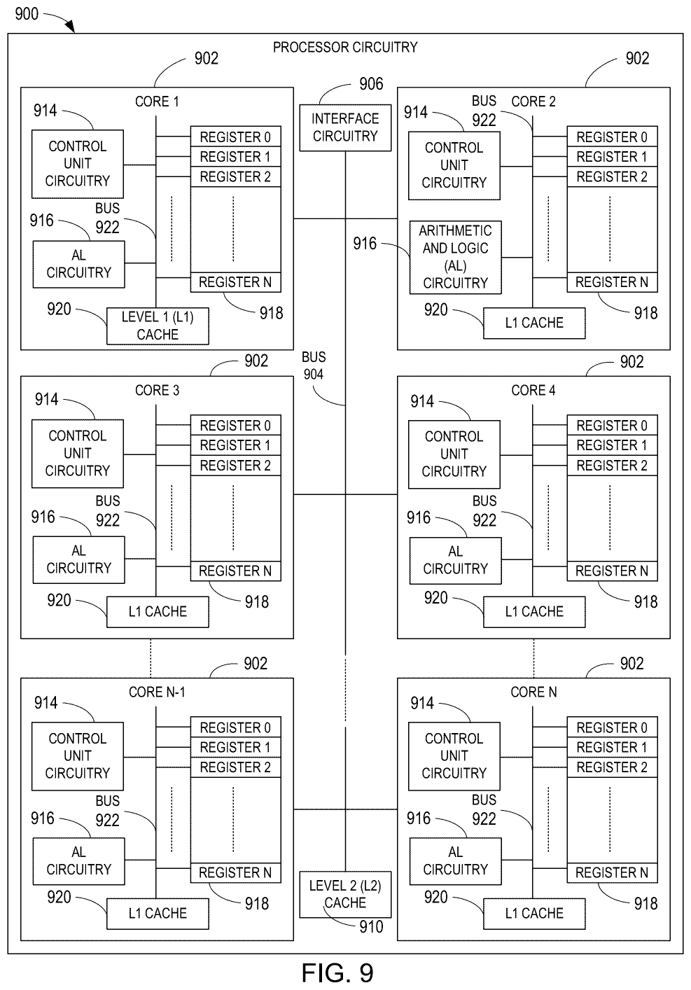

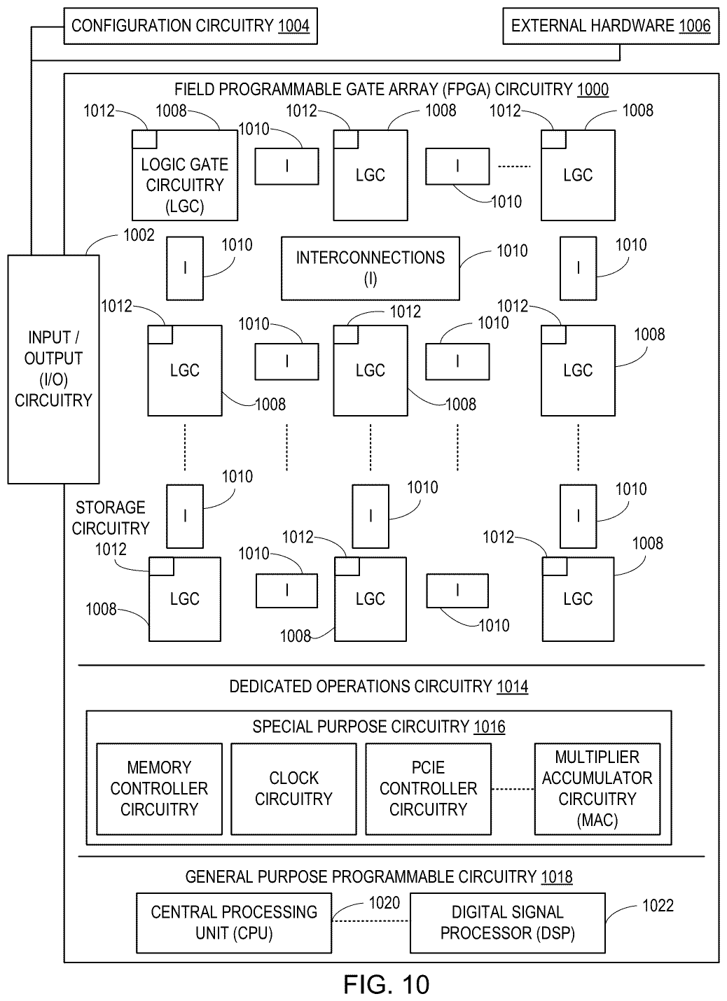

In some examples, the preset mode selection circuitry 110 includes means for selecting a first preset mode. For example, the means for selecting a first preset mode may be implemented by the initial mode selection circuitry 210. In some examples, the initial mode selection circuitry 210 may be instantiated by programmable circuitry such as the example programmable circuitry 812 of FIG. 8. For instance, the initial mode selection circuitry 210 may be instantiated by the example microprocessor 900 of FIG. 9 executing machine executable instructions such as those implemented by at least blocks 605, 610 of FIG. 6, and blocks 705, 710 of FIG. 7. In some examples, the initial mode selection circuitry 210 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the initial mode selection circuitry 210 may be instantiated by any other combination of hardware, software, and/or firmware. For example, the initial mode selection circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The update mode selection circuitry 220 selects a subsequent or second preset mode based on a set of one or more encoding characteristics 160 (FIG. 1) associated with a given frame of the input video 150 (FIG. 1), as described above in connection with FIG. 1. The set of one or more encoding characteristics 160 may include and/or be determined based on one or more lookahead characteristic(s), a quantizer characteristic(s), signal-to-noise ratio characteristic(s) associated with the second frame, etc. In some examples, when the encoding time of the second frame is limited by a bit packing operation of the video encoder circuitry 130, the update mode selection circuitry 220 selects a second preset mode that is associated with higher compression quality and lower encoder speed than the first preset mode. In some examples, if the update mode selection circuitry 220 determines that the encoding time of the second frame is not limited by the bit packing operation of the video encoder circuitry 130, the update mode selection circuitry 220 retains the first preset mode to encode the second frame, as described above in connection with FIG. 1.

In some examples, when a frame type of a given (e.g., second) frame in a group of pictures is a reference frame in the group of pictures, the update mode selection circuitry 220 selects a second preset mode associated with higher compression quality and lower encoder speed than the first preset mode, as described above. For example, this second preset mode can be the “slower” preset mode described above.

In some examples, the update mode selection circuitry 220 selects a second preset mode based on comparison of a visual quality metric to a threshold, as described above. The visual quality metric is associated with encoding the given (e.g., second) frame. The threshold can be a visually lossless visual quality. Examples of visual quality metrics of a given frame include a signal-to-noise (SNR) ratio characteristic, a prior encoding size, a quantizer characteristic, a content type, as described above in connection with FIG. 1.

In some examples, the update mode selection circuitry 220 selects a second preset mode based on a determination that a time to encode the second frame based on a second preset mode satisfies a threshold, as described above. The threshold can be a time constraint associated with achieving real-time encoding, as described above in connection with FIG. 1.

In some examples the update mode selection circuitry 220 selects a second preset mode based on whether the second frame corresponds to a scene change, as described above. The update mode selection circuitry 220 selects a “slower” preset mode if the second frame corresponds to a scene change, as described above in connection with FIG. 1.

In some examples, the preset mode selection circuitry 110 includes means for selecting a second or subsequent preset mode based on encoding characteristics, encoding time or other factors. For example, the means for selecting a second preset mode may be implemented by the update mode selection circuitry 220. In some examples, the update mode selection circuitry 220 may be instantiated by programmable circuitry such as the example programmable circuitry 812 of FIG. 8. For instance, the update mode selection circuitry 220 may be instantiated by the example microprocessor 900 of FIG. 9 executing machine executable instructions such as those implemented by at least blocks 625, 630 of FIG. 6 and blocks 715, 720, 735, 740, 745, 750, 755 of FIG. 7. In some examples, the update mode selection circuitry 220 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the update mode selection circuitry 220 may be instantiated by any other combination of hardware, software, and/or firmware. For example, the update mode selection circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The configuration circuitry 230 provides the selected preset mode value 120 (FIG. 1) to the preset mode input 125 (FIG. 1) of the video encoder circuitry 130 (FIG. 1). For example, the configuration circuitry 230 may output the selected preset mode value 120 as a digital value, a signal (e.g., voltage, current, etc.) value, a register setting, a data word, etc. As described above, the video encoder circuitry 130 uses the preset mode value applied to the preset mode input 125 to configure a particular combination of encoder parameters settings corresponding to the preset mode value. In the illustrated example, the configuration circuitry 230 configures the video encoder circuitry 130 with a first or initial preset mode value 120 based on a first or initial preset mode selection made by the initial preset mode selection circuitry 210. The configuration circuitry 230 then configures the video encoder circuitry 130 with a second or updated preset mode value based on a second or subsequent preset mode selection made by the updated preset mode selection circuitry 210.

In some examples, the preset mode selection circuitry 110 includes means for configuring a preset mode of a video encoder. For example, the means for configuring may be implemented by the configuration circuitry 230. In some examples, the configuration circuitry 230 may be instantiated by programmable circuitry such as the example programmable circuitry 812 of FIG. 8. For instance, the configuration circuitry 230 may be instantiated by the example microprocessor 900 of FIG. 9 executing machine executable instructions such as those implemented by at least blocks 615, 635 of FIG. 6 and blocks 725, 530 of FIG. 7. In some examples, the configuration circuitry 230 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the configuration circuitry 230 may be instantiated by any other combination of hardware, software, and/or firmware. For example, the configuration circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the preset mode selection circuitry 110 of FIG. 1 is illustrated in FIG. 2, one or more of the elements, processes, and/or devices illustrated in FIG. 2 may be combined, divided, re-arranged, omitted, eliminated, and/or implemented in any other way. Further, the example initial mode selection circuitry 210, the example update mode selection circuitry 220, the example configuration circuitry 230 and/or, more generally, the example preset mode selection circuitry 110 of FIG. 2, may be implemented by hardware alone or by hardware in combination with software and/or firmware. Thus, for example, any of the example initial mode selection circuitry 210, the example update mode selection circuitry 220, the example configuration circuitry 230, and/or, more generally, the example preset mode selection circuitry 110, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example preset mode selection circuitry 110 of FIG. 2 may include one or more elements, processes, and/or devices in addition to, or instead of, those illustrated in FIG. 2, and/or may include more than one of any or all of the illustrated elements, processes and devices.

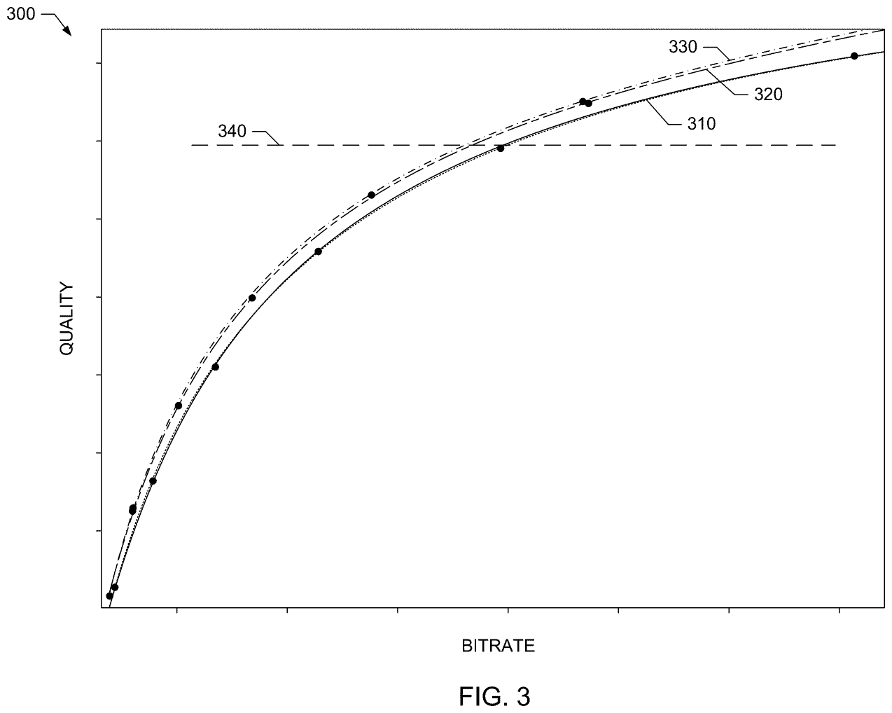

FIG. 3 depicts an example graph 300 illustrating different quality at different bitrates produced by the video encoder circuitry 130 based on different preset modes selected by the preset mode selection circuitry 110. In the example graph 300, the x-axis represents the bitrate of the encoded video, and the y-axis represents the quality of the encoded video. In the graph 300, the different quality at different bitrates produces different quality results. The graph 300 includes curves or lines 310, 320, 330 that illustrate the bitrate-quality trade-off of three different video streams. As the bitrate increases, the quality of the encoded video generally improves, but the rate of improvement gradually diminishes. At some point, further increases in bitrate may result in diminishing returns in terms of quality improvement. When the bitrate is fairly high, there is no visual difference in the results since the difference is imperceptible to a viewer. For example, at point 340, when the encoded video has a visually lossless quality, and further increases in bitrate will result in minimal improvements in quality. When the encoded video is visually lossless, the preset mode selection circuitry 110 switching to a “faster” preset mode with faster encoding speed can provide a two to five times increase in encoding speed while still maintaining the visual quality.

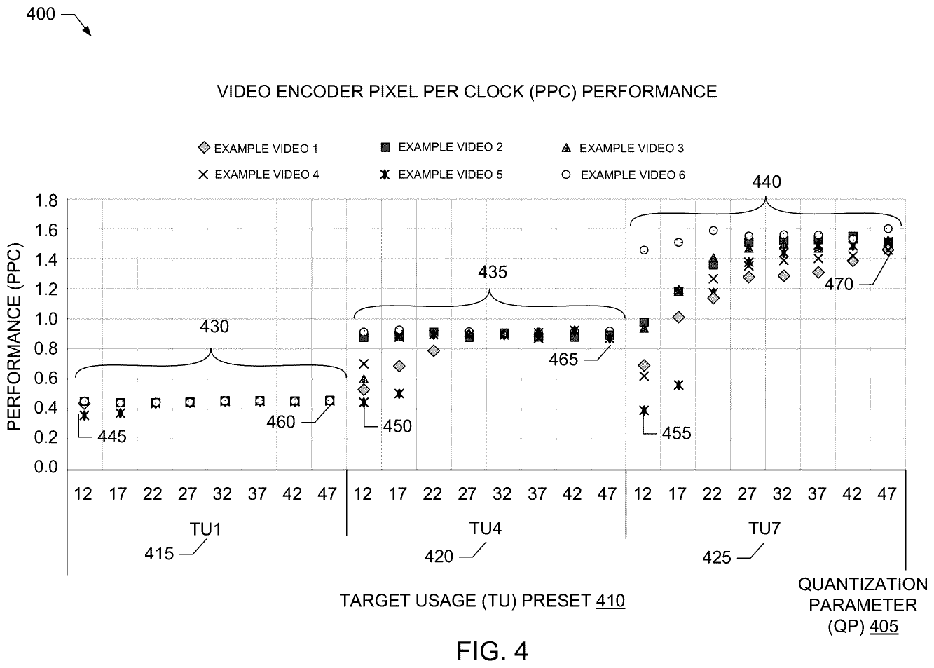

FIG. 4 illustrates an example chart 400 of different performance of a video encoder based on different video content and different preset modes, referred to as target usage (TU) preset in the figure. The x-axis represents different quantization parameters (QP) 405 and different preset modes or TUs 410. The QP 405 on the x-axis represents different bitrates. For example, a low QP (e.g., QP12, QP17) represents a high bitrate and a high QP (e.g., QP 42, QP47) represents a low bitrate. For example, QP12 would have a higher bitrate than QP47. As described above, the TU preset provides a quick way to adjust a combination of encoder parameter settings that tradeoff between encoding quality and encoding speed. In the illustrated example, the TU1 415 preset represents a “very slow” preset mode associated with the best encoding quality. TU4 420 preset represents a “medium” preset mode associated with a balanced encoding performance and quality. The TU4 preset provides a balanced encoding speed and compression efficiency. TU7 425 preset represents a “very fast” preset mode associated with the fastest encoding speed. The y-axis represents the video encoder pixel per clock performance (PPC).

Example video 1, 2, and 3 are videos with simple content, such as a black screen or a video of a flower with minimal movement. For videos with simple content, no matter what bitrate is used (e.g., QP 12 to QP47), the performance is the same or similar as shown by the diamond-shaped data point for video 1, the square-shaped data point for video 2, and the triangle-shaped data point for video 3. At TU1 415 preset, video 1 pixel per clock (PPC) performance remains the same at 0.4 PPC for different bitrate (e.g., from QP12 to QP47). Similarly for video 2 and 3, the video encoder PPC performance remains the same at 0.4 PPC at different bitrate when the preset mode is TU1 415.

Example videos 4, 5, 6 have complicated or highly complex content (e.g., a video of a marathon with fast movement of runners dressed in different colors and surrounding objects such as leaves moving in a tree, or building). At a high bitrate (e.g., QP 12) for each preset mode TU1 415, TU4 420 and TU7 425, the video encoder performance is the same. For example, an x-shaped data point 445, 450, 455 shows example video 5 with the same 0.4 PPC at QP 12 when the preset mode is TU1 415, TU4 420 and TU7 425. However, at a lower bitrate (e.g., QP 47), the video encoder performance improves from TU1 415 to TU7 425. The example video 5 x-shaped data point 460 at QP47 in preset mode TU1 (“very slow” preset mode) shows a 0.4 PPC video encoder performance. The video 5 data point 465 shows the video encoder performance increases to about 1.0 PPC at QP47 in TU4 420 preset (e.g., “medium” preset mode). The video 5 data point 470 shows the video encoder performance increases to 1.6 PPC at QP47 in TU7 425 preset (e.g., “very fast” preset mode). At a low bitrate (e.g., high QP), the video encoder performs better using a “fast” preset mode. The video encoder performance at TU4 435 preset doubles the video encoder performance at TU1 430 preset. The video encoder performance at TU7 440 preset doubles the video encoder performance at TU4 435 preset. The compression efficiency at TU1 415 preset is better than the compression efficiency at TU4 420 preset. Similarly, the compression efficiency at TU4 420 preset is better than the compression efficiency at TU7 425 preset. However, at a high bit rate (e.g., QP12), the performance of the video encoder is the same whether the preset mode is at TU1 415, TU4 420 or TU7 425. The bitrate, content complexity, and number of coefficients encoded by a CABAC engine determine the video encoder performance.

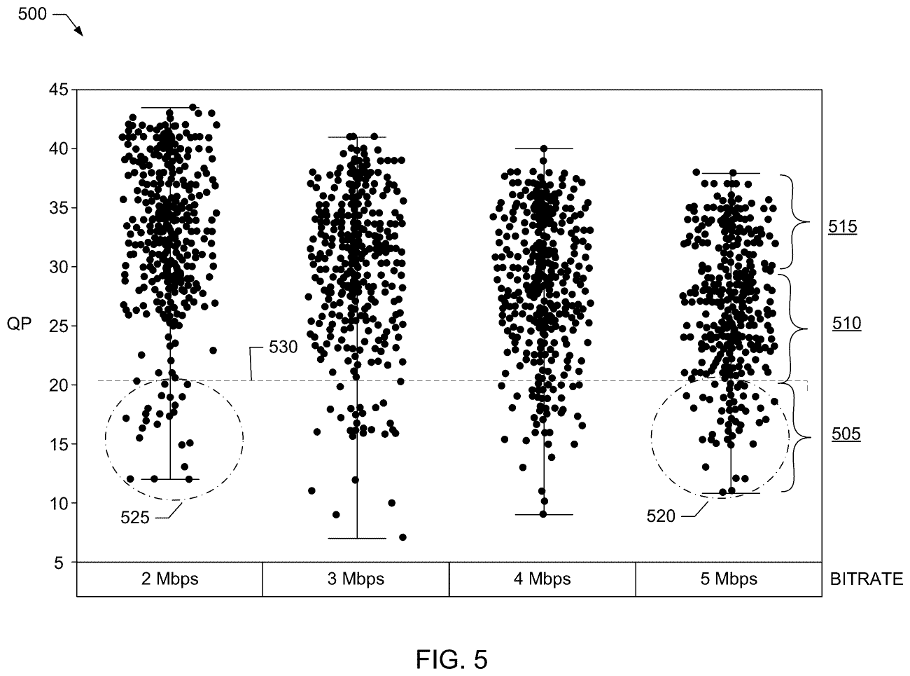

FIG. 5 is an example chart 500 that illustrates frame distribution of a 720p video at different quantization parameter (QP) and different bitrate. An example 720p video is a video of a trailer which includes scene changes that results in high temporal complexity. The x-axis in chart 500 represents four different bitrates and the y-axis represents the QP value.

Chart 500 illustrates a piece of video content encoded at four different bitrates, 2 megabits per second (Mbps), 3 Mbps, 4 Mbps and 5 Mbps. The piece of content is a 740p video. In chart 500, the data points represent a frame within the video. The data points represent the distribution of the frames at different QP and at different bitrates. The QP value on the y-axis determines the preset mode selected for the video encoder. For example, for QP10-QP20, a TU7 preset 505 is selected. TU7 is “very fast” preset mode associated with fast encoding speed. At QP10-QP20, there are more frames at 5 Mbps 520 than at 2 Mbps 525. If QP20 530 is set as a threshold where the output video quality is visually lossless, then there are more visually lossless frames at 5 Mbps 520 than at 2 Mbps 525.

Chart 500 illustrates the same number of frames at each bitrate for the input video. However, the distribution of frames at the different QP is different at different bitrates. For example, at 5 Mbps bitrate, the number of frames distributed in the low QP values QP10-QP20 505, medium QP values QP20-QP30 510, and high QP values QP30-QP40 515 are different than the number of frames distributed at 2 Mbps bitrates in the low, medium and high QP values. At QP10-QP20 505 a TU7 preset is selected and more frames fall in this QP values at 5 Mbps than at 2 Mbps. Similarly, at QP20-QP30 510, where a TU4 preset is selected, there are more frames at this QP values when the bitrate is 5 Mbps bitrate than at the lower bitrate. At QP30-QP40 515, TU1 preset (“very slow” preset mode) is selected. At this “very slow” preset mode, the distribution of frames at each bitrate are almost the same.

Flowchart(s) representative of example machine readable instructions, which may be executed by programmable circuitry to implement and/or instantiate the preset mode selection circuitry 110 of FIG. 2 and/or representative of example operations which may be performed by programmable circuitry to implement and/or instantiate the preset mode selection circuitry 110 of FIG. 2, are shown in FIGS. 6-7. The machine readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6-7, many other methods of implementing the example preset mode selection circuitry 110 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6-7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 6 is a flowchart representative of example machine readable instructions and/or example operations 600 that may be executed, instantiated, and/or performed by programmable circuitry to implement the preset mode selection circuitry 110 to adaptively configure video encoder preset modes. The example machine-readable instructions and/or the example operations 600 of FIG. 6 begin at block 605, at which the initial mode selection circuitry 210 (FIG. 2) obtains a set of stream characteristics 140 (FIG. 1) for an input video (block 605). The initial mode selection circuitry 210 selects a first or initial preset mode for the video encoder circuitry 130 (FIG. 1) based on the set of stream characteristics 140 (block 610). The configuration circuitry 230 (FIG. 2) configures the video encoder circuitry 130 based on the selected preset mode (block 615). The configuration circuitry 230 sets or writes a preset mode value 120 (FIG. 1) to the preset mode input 125 (FIG. 1) of the video encoder circuitry 130. The preset mode input 125 sets the encoder parameters in the encoder circuitry 130 to a particular combination of settings based on the tradeoff between encoding speed and encoder's compression efficiency. A preset mode that prioritizes the encoder's compression efficiency has better encoding quality whereas a preset mode that prioritizes the encoder's speed has better encoding performance.

At block 620, for each video frame, the update mode selection circuitry 220 (FIG. 2) obtains a set of encoding characteristics 160 (FIG. 1) for a given frame (block 625). This set of encoding characteristics 160 is discussed above in connection with FIG. 1. The update mode selection circuitry 220 selects a subsequent or second preset mode for the video encoder circuitry 130 based on the set of encoding characteristics 160 (block 630). The configuration circuitry 230 configures the video encoder circuitry 130 to encode the given frame based on the second selected preset mode (block 635). The configuration circuitry 230 configures the video encoder circuitry 130 by outputting the preset mode value 120 (FIG. 1) to the preset mode input 125 of the video encoder circuitry 130. The update mode selection circuitry 220 determines whether all video frames are encoded (block 640). If all video frames are not encoded (block 640: NO), control returns to block 620. If all video frames are encoded (block 640: YES), the example instructions and/or operations 600 of FIG. 6 end.

FIG. 7 is a flowchart representative of second example machine readable instructions and/or example operations 700 that may be executed, instantiated, and/or performed by programmable circuitry to implement the preset mode selection circuitry 110 to adaptively configure video encoder preset modes. The example machine-readable instructions and/or the example operations 700 of FIG. 7 begin at block 705, at which the initial mode selection circuitry 210 obtains a set of stream characteristics 140 (FIG. 1) for input video. The initial mode selection circuitry 210 selects a first or initial preset mode to configure the video encoder circuitry 130 (block 710). At block 715, the update mode selection circuitry 220 checks each subsequent frame. For each subsequent frame, the update mode selection circuitry 220 obtains a set of encoding characteristics 160 (FIG. 1) for the given frame (block 720). The update mode selection circuitry 220 determines if the encoding process or codec in the video encoder circuitry 130 is CABAC limited (block 725). If the video encoder 130 is CABAC limited (block 725: YES), the update mode selection circuitry 220 adjusts the preset mode to a higher quality mode (“slower” preset mode) (block 730), which is output by the configuration circuitry 230. The example instructions and/or operations 700 of FIG. 7 end. If the update mode selection circuitry 220 determines that the video encoder 130 is not CABAC limited, (block 725: NO), control proceeds to block 735.

At block 735, the update mode selection circuitry 220 determines whether the second frame corresponds to a scene change. If the second frame includes scene change (block 735: YES), the update mode selection circuitry 220 determines the spatial complexity of the frame (block 740). Control proceeds to block 745. If the second frame does not include a scene change (block 735: NO), the update mode selection circuitry 220 determines if the video quality is visually lossless (block 745). If the video quality has reached the threshold of being visually lossless (block 745: YES), the update mode selection circuitry 220 adjusts the preset mode to a higher performance mode (“faster” preset mode) (block 750), which is output by the configuration circuitry 230. The example instructions and/or operations 700 of FIG. 7 then end. However, if the video quality has not reached the threshold of being visually lossless (block 745: NO), the update mode selection circuitry 220 adjusts the preset mode to a higher quality mode (“slower” preset mode) (block 755), which is output by the configuration circuitry 230. The example instructions and/or operations 700 of FIG. 7 then end.

FIG. 8 is a block diagram of an example programmable circuitry platform 800 structured to execute and/or instantiate the example machine-readable instructions and/or the example operations of FIGS. 6-7 to implement the preset mode selection circuitry of FIG. 2. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example initial mode selection circuitry 210, the example update mode selection circuitry 220, the example configuration circuitry 230, and/or, more generally, the example preset mode selection circuitry 110.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIGS. 6-7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 6-7 to effectively instantiate the circuitry of FIG. 2 as logic circuits to perform operations corresponding to those machine readable instructions. In some such examples, the circuitry of FIG. 2 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 6-7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCle bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCle bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart(s) of FIGS. 6-7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 6-7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6-7. As such, the FPGA circuitry 1000 may be configured and/or structured to effectively instantiate some or all of the operations/functions corresponding to the machine readable instructions of the flowchart(s) of FIGS. 6-7 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIGS. 6-7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIGS. 6-7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCle controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart(s) of FIGS. 6-7 to perform first operation(s)/function(s), the FPGA circuitry 1000 of FIG. 10 may be configured and/or structured to perform second operation(s)/function(s) corresponding to a second portion of the machine readable instructions represented by the flowcharts of FIG. 6-7, and/or an ASIC may be configured and/or structured to perform third operation(s)/function(s) corresponding to a third portion of the machine readable instructions represented by the flowcharts of FIGS. 6-7.

It should be understood that some or all of the circuitry of FIG. 2 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 2 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

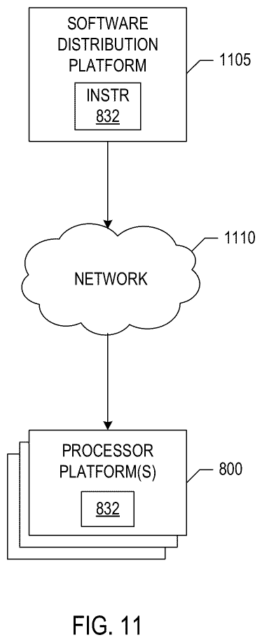

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIGS. 6-7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIG. 6-7, may be downloaded to the example programmable circuitry platform 800, which is to execute the machine readable instructions 832 to implement the preset mode selection circuitry. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that adaptively configure video encoder preset modes. Disclosed systems, apparatus, articles of manufacture, and methods improve the efficiency of using a computing device by obtaining sets of stream characteristics and frame encoding characteristics, and dynamically selecting a preset mode to configure a video encoder circuitry to achieve a desired tradeoff between encoder performance and quality. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to adaptively configure video encoder preset modes are disclosed herein. Further examples and combinations thereof include the following.

Example 1 includes an apparatus comprising interface circuitry to obtain a video to be encoded, instructions, and at least one processor circuit to be programmed by the instructions to configure a video encoder to encode a first frame of the video based on a first preset mode of a plurality of preset modes associated respectively with a plurality of different relative encoder performance targets, select a second preset mode of the plurality of preset modes based on one or more characteristics associated with a second frame of the video, the second preset mode different from the first preset mode, and configure the video encoder to encode the second frame based on the second preset mode.

Example 2 includes the apparatus of example 1, wherein the second preset mode is associated with higher compression quality and lower encoder speed than the first preset mode, the one or more characteristics includes a first characteristic that indicates whether an encoding time of the second frame is limited by a bit packing operation of the video encoder, and one or more of the at least one processor circuit is to select the second preset mode to encode the second frame based on the first characteristic indicating the encoding time of the second frame is limited by the bit packing operation of the video encoder.

Example 3 includes the apparatus of example 1 or example 2, wherein the one or more of the at least one processor circuit is to determine whether to retain the first preset mode to encode the second frame based on (i) the first characteristic indicating the encoding time of the second frame is not limited by the bit packing operation of the video encoder and (ii) a second characteristic of the second frame.

Example 4 includes the apparatus of any one of examples 1 to 3, wherein the second preset mode is associated with higher compression quality and lower encoder speed than the first preset mode, the one or more characteristics includes a first characteristic that indicates a frame type of the second frame in a group of pictures, and one or more of the at least one processor circuit is to select the second preset mode to encode the one or more frames of the group of pictures including the second frame based on the first characteristic indicating the second frame is a reference frame in the group of pictures.

Example 5 includes the apparatus of any one of examples 1 to 4, wherein the one or more characteristics includes a visual quality metric associated with encoding the second frame, and one or more of the at least one processor circuit is to select the second preset mode based on comparison of the visual quality metric to a threshold.

Example 6 includes the apparatus of any one of examples 1 to 5, wherein one of more of the at least one processor circuit is to select the second preset mode based on (i) the one or more characteristics of the second frame and (ii) a determination that a time to encode the second frame based on the second preset mode satisfies a threshold.

Example 7 includes the apparatus of any one of examples 1 to 6, wherein one of more of the at least one processor circuit is to select the second preset mode based on (i) the one or more characteristics of the second frame and (ii) whether the second frame corresponds to a scene change.

Example 8 includes the apparatus of any one of examples 1 to 7, wherein one of more of the at least one processor circuit is to determine the one or more characteristics based on a lookahead characteristic or a quantizer characteristic.

Example 9 includes the apparatus of any one of examples 1 to 8, wherein one or more of the at least one processor circuit is to select the first preset mode based on one or more stream characteristics of the video.

Example 10 includes the apparatus of any one of examples 1 to 9, wherein the one or more stream characteristics includes at least one of a bitrate of the video, a resolution of the video, or a frame rate of the video.

Example 11 includes at least one non-transitory machine-readable medium comprising machine-readable instructions to cause at least one processor circuit to at least configure a video encoder to encode a first frame of a video based on a first preset mode of a plurality of preset modes associated respectively with a plurality of different relative encoder performance targets, select a second preset mode of the plurality of preset modes based on one or more characteristics associated with a second frame of the video, the second preset mode different from the first preset mode, and configure the video encoder to encode the second frame based on the second preset mode.

Example 12 includes the at least one non-transitory machine-readable medium of example 11, wherein the second preset mode is associated with higher compression quality and lower encoder speed than the first preset mode, the one or more characteristics includes a first characteristic that indicates whether an encoding time of the second frame is limited by a bit packing operation of the video encoder, and the machine-readable instructions are to cause one or more of the at least one processor circuit to select the second preset mode to encode the second frame based on the first characteristic indicating the encoding time of the second frame is limited by the bit packing operation of the video encoder.

Example 13 includes the at least one non-transitory machine-readable medium of example 11 or example 12, wherein the machine-readable instructions are to cause one or more of the at least one processor circuit to determine whether to retain the first preset mode to encode the second frame based on (i) the first characteristic indicating the encoding time of the second frame is not limited by the bit packing operation of the video encoder and (ii) a second characteristic of the second frame.

Example 14 includes the at least one non-transitory machine-readable medium of any one of examples 11 to 13, wherein the second preset mode is associated with higher compression quality and lower encoder speed than the first preset mode, the one or more characteristics includes a first characteristic that indicates a frame type of the second frame in a group of pictures, and the machine-readable instructions are to cause one or more of the at least one processor circuit to select the second preset mode to encode the one or more frames of the group of pictures including the second frame based on the first characteristic indicating the second frame is a reference frame in the group of pictures.

Example 15 includes the at least one non-transitory machine-readable medium of any one of examples 11 to 14, wherein the one or more characteristics includes a visual quality metric associated with encoding the second frame, and the machine-readable instructions are to cause one or more of the at least one processor circuit to select the second preset mode based on comparison of the visual quality metric to a threshold.

Example 16 includes a method comprising configuring a video encoder to encode a first frame of a video based on a first preset mode of a plurality of preset modes associated respectively with a plurality of different relative encoder performance targets, selecting a second preset mode of the plurality of preset modes based on one or more characteristics associated with a second frame of the video, the second preset mode different from the first preset mode, and configuring the video encoder to encode the second frame based on the second preset mode.

Example 17 includes the method of example 16, further including selecting the second preset mode based on (i) the one or more characteristics of the second frame and (ii) a determination that a time to encode the second frame based on the second preset mode satisfies a threshold.

Example 18 includes the method of examples 16 or 17, further including selecting the second preset mode based on (i) the one or more characteristics of the second frame and (ii) whether the second frame corresponds to a scene change.

Example 19 includes the method of any one of examples 16 to 18, further including determining the one or more characteristics based on a lookahead characteristic or a quantizer characteristic.

Example 20 includes the method of any one of examples 16 to 19, wherein the one or more characteristics is one or more encoding characteristics of the second frame, and further including selecting the first preset mode based on one or more stream characteristics of the video.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry to obtain a video to be encoded;
instructions; and
at least one processor circuit to be programmed by the instructions to:
configure a video encoder to encode a first frame of the video based on a first preset mode of a plurality of preset modes associated respectively with a plurality of different relative encoder performance targets;
select a second preset mode of the plurality of preset modes based on one or more characteristics associated with a second frame of the video, the second preset mode different from the first preset mode; and
configure the video encoder to encode the second frame based on the second preset mode.

2. The apparatus of claim 1, wherein the second preset mode is associated with higher compression quality and lower encoder speed than the first preset mode, the one or more characteristics include a first characteristic that indicates whether an encoding time of the second frame is limited by a bit packing operation of the video encoder, and one or more of the at least one processor circuit is to select the second preset mode to encode the second frame based on the first characteristic indicating the encoding time of the second frame is limited by the bit packing operation of the video encoder.

3. The apparatus of claim 2, wherein the one or more of the at least one processor circuit is to determine whether to retain the first preset mode to encode the second frame based on (i) the first characteristic indicating the encoding time of the second frame is not limited by the bit packing operation of the video encoder and (ii) a second characteristic of the second frame.

4. The apparatus of claim 1, wherein the second preset mode is associated with higher compression quality and lower encoder speed than the first preset mode, the one or more characteristics include a first characteristic that indicates a frame type of the second frame in a group of pictures, and one or more of the at least one processor circuit is to select the second preset mode to encode the one or more frames of the group of pictures including the second frame based on the first characteristic indicating the second frame is a reference frame in the group of pictures.

5. The apparatus of claim 1, wherein the one or more characteristics include a visual quality metric associated with encoding the second frame, and one or more of the at least one processor circuit is to select the second preset mode based on comparison of the visual quality metric to a threshold.

6. The apparatus of claim 1, wherein one of more of the at least one processor circuit is to select the second preset mode based on (i) the one or more characteristics of the second frame and (ii) a determination that a time to encode the second frame based on the second preset mode satisfies a threshold.

7. The apparatus of claim 1, wherein one of more of the at least one processor circuit is to select the second preset mode based on (i) the one or more characteristics of the second frame and (ii) whether the second frame corresponds to a scene change.

8. The apparatus of claim 1, wherein one of more of the at least one processor circuit is to determine the one or more characteristics based on a lookahead characteristic or a quantizer characteristic.

9. The apparatus of claim 1, wherein one or more of the at least one processor circuit is to select the first preset mode based on one or more stream characteristics of the video.

10. The apparatus of claim 9, wherein the one or more stream characteristics include at least one of a bitrate of the video, a resolution of the video, or a frame rate of the video.

11. At least one non-transitory machine-readable medium comprising machine-readable instructions to cause at least one processor circuit to at least:
configure a video encoder to encode a first frame of a video based on a first preset mode of a plurality of preset modes associated respectively with a plurality of different relative encoder performance targets;
select a second preset mode of the plurality of preset modes based on a one or more characteristics associated with a second frame of the video, the second preset mode different from the first preset mode; and
configure the video encoder to encode the second frame based on the second preset mode.

12. The at least one non-transitory machine-readable medium of claim 11, wherein the second preset mode is associated with higher compression quality and lower encoder speed than the first preset mode, the one or more characteristics includes a first characteristic that indicates whether an encoding time of the second frame is limited by a bit packing operation of the video encoder, and the machine-readable instructions are to cause one or more of the at least one processor circuit to select the second preset mode to encode the second frame based on the first characteristic indicating the encoding time of the second frame is limited by the bit packing operation of the video encoder.

13. The at least one non-transitory machine-readable medium of claim 12, wherein the machine-readable instructions are to cause one or more of the at least one processor circuit to determine whether to retain the first preset mode to encode the second frame based on (i) the first characteristic indicating the encoding time of the second frame is not limited by the bit packing operation of the video encoder and (ii) a second characteristic of the second frame.

14. The at least one non-transitory machine-readable medium of claim 11, wherein the second preset mode is associated with higher compression quality and lower encoder speed than the first preset mode, the one or more characteristics includes a first characteristic that indicates a frame type of the second frame in a group of pictures, and the machine-readable instructions are to cause one or more of the at least one processor circuit to select the second preset mode to encode the one or more frames of the group of pictures including the second frame based on the first characteristic indicating the second frame is a reference frame in the group of pictures.

15. The at least one non-transitory machine-readable medium of claim 11, wherein the one or more characteristics includes a visual quality metric associated with encoding the second frame, and the machine-readable instructions are to cause one or more of the at least one processor circuit to select the second preset mode based on comparison of the visual quality metric to a threshold.

16. A method comprising:
configuring a video encoder to encode a first frame of a video based on a first preset mode of a plurality of preset modes associated respectively with a plurality of different relative encoder performance targets;
selecting a second preset mode of the plurality of preset modes based on a one or more characteristics associated with a second frame of the video, the second preset mode different from the first preset mode; and
configuring the video encoder to encode the second frame based on the second preset mode.

17. The method of claim 16, further including selecting the second preset mode based on (i) the one or more characteristics of the second frame and (ii) a determination that a time to encode the second frame based on the second preset mode satisfies a threshold.

18. The method of claim 16, further including selecting the second preset mode based on (i) the one or more characteristics of the second frame and (ii) whether the second frame corresponds to a scene change.

19. The method of claim 16, further including determining the one or more characteristics based on a lookahead characteristic or a quantizer characteristic.

20. The method of claim 16, wherein the one or more characteristics is one or more encoding characteristics of the second frame, and further including selecting the first preset mode based on a one or more stream characteristics of the video.
